(19) United States
(12) Patent Application Publication
(10) Pub. No.: US 2004/0018857 A1
(43) Pub. Date: Jan. 29, 2004

(54) Predictive number input dialing

(76) Inventors: Ramanathan Asokan, Cary, NC (US); Karin Spalink, Durham, NC (US)

Correspondence Address: STEVEN B. PHILLIPS, MOORE & VAN ALLEN, 2200 WEST MAIN STREET, SUITE 800, DURHAM, NC, 27705, US

(21) Appl. No.: 10/207,640

(22) Filed: Jul. 29, 2002

(51) Int. Cl. H04M 1/00

(52) U.S. Cl. 455/564; 455/565

(57) ABSTRACT

A method and apparatus for predictive dialing in a mobile terminal is disclosed. The present invention is intended to reduce the time and number of inputs required to initiate a connection from a mobile terminal. When initial characters of a network identifier (such as a phone number, e-mail address, or URL) are received, the present invention facilitates entry of the additional characters using a matching process. A search function attempts to match the entered characters with a plurality of network identifiers stored in the mobile terminal's memory. If matches are found, the results are displayed to the user. If the user enters additional characters, the search is repeated on the list of displayed results, and a new list of results is displayed. The process ends when either no matches are found or when the user makes a selection from the displayed results.

### BACKGROUND OF THE INVENTION

Prior art mobile terminals (e.g. cell phones) require that a user identify the telephone number to be dialed either by a user selection of a telephone number listed in a directory within the terminal or by entering the telephone number on the terminal keypad. This requires a mobile terminal user to either individually enter every digit of the entire phone number, or search through a list of stored numbers, before a call can be initiated. This is also true for Internet addresses, such as e-mail addresses and URLs. This can be a time consuming and often exhausting process.

What is needed is a method and apparatus for matching the entered characters of a phone number, e-mail address, or URL to the available lists that are stored in the mobile terminal's memory, and allowing the user to select from the results to initiate a connection from a mobile terminal.

### SUMMARY

The present invention is to a predictive dialing method and apparatus that reduces the time and effort required from a user to initiate a connection from a mobile terminal. When initial characters of a network identifier (such as a phone number, e-mail address, or URL) are entered by the user, the present invention searches through a plurality of network identifiers stored in the mobile terminal's memory for possible matches. The searching process attempts to match the entered initial characters with the initial characters of any of the stored network identifiers. If the initial characters entered by the user match the initial characters of any of the stored network identifiers, these matching stored network identifiers are displayed to the user as a first subset of stored network identifiers. If the user selects one of these displayed results, or if no matches are found, the process ends. If no match is found, the user is able to manually enter the remaining characters of the desired network identifier. If the user enters an additional character, the present invention searches through the first subset of stored network identifiers, and if any matches are found, the results are displayed to the user as a reduced subset of network identifiers. This process of searching the displayed subset and displaying a reduced subset repeats until a user selects one of the displayed results, until no further matches are found, or until a predetermined number of digits has been entered with no selection. The process may also end if a user does not enter any additional characters for a specified length of time.

### BRIEF DESCRIPTION OF THE DRAWINGS

FIG. 1 is a plain view illustration of a typical mobile terminal.

FIG. 2 is a block diagram illustration of a mobile terminal implementing the present invention.

FIGS. 3A, 3B, and 3C are flowchart diagrams illustrating the steps for performing the present invention.

### DETAILED DESCRIPTION

The principles of predictive text input are known in the prior art, such as in word processing programs where they provide user assistance in recognizing terms that have a high frequency of use. However, these principles have yet to be applied in the context of mobile terminals, where they would be useful in reducing the time needed to initiate a call. The present invention addresses such a situation using a matching process which applies the principles of predictive text input to network identifiers stored in the memory of a mobile terminal. “Network identifiers” may include one or more of the following: phone numbers, e-mail addresses, and world-wide web addresses/URLs. When characters are entered on the mobile terminal's display, the present invention attempts to match the entered characters to a phone number or other network identifier available in various storage locations of the phone, and displays any matching stored network identifiers to the user. This allows the user to select from the matches and initiate a call far more quickly and easily than he could by entering every character of the desired network identifier. This also reduces the chances of user error in entering the desired network identifier, which is important because the user will typically incur charges for all outgoing calls from the mobile terminal, regardless of whether the call was placed to the desired party.

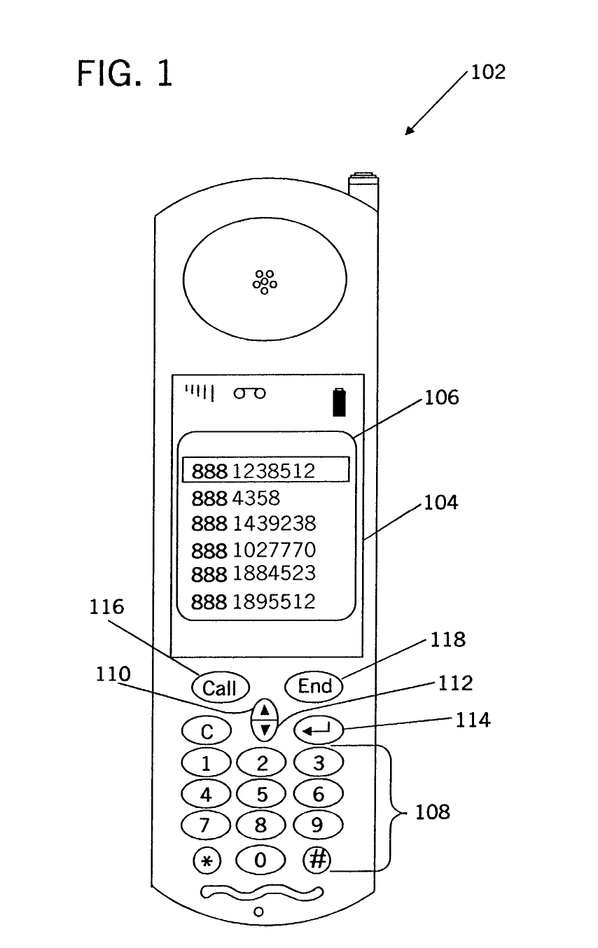

FIG. 1 illustrates a typical layout of a mobile terminal 102. It should be noted, however, that the present invention is not limited in its use to any particular terminal layout. In FIG. 1, the terminal 102 includes a display 104, used to present designated input GUI's 106 (Graphical User Interface) to the user of the mobile terminal. A Graphical User Interface is a program interface that has pictures as well as words on the screen. This type of interface takes advantage of a display's graphics capabilities to make the program easier to use. Graphical user interfaces can free the user from learning complex command languages by using windows, icons, and pull-down menus to enter different commands. These input GUI's may be used to enter network identifiers such as phone numbers, e-mail addresses, and worldwide web addresses/URLs in the present invention. It should be noted, however, that the present invention is not limited to any one particular method of entering network identifiers. The terminal 102 also includes an alphanumeric keypad 108, a Scroll Up button 110, a Scroll Down button 112, an Enter/YES button 114, a Talk/Call button 116, and an End button 118. Note that the invention is not limited to use in mobile terminals of this configuration, but can be used in any mobile terminal.

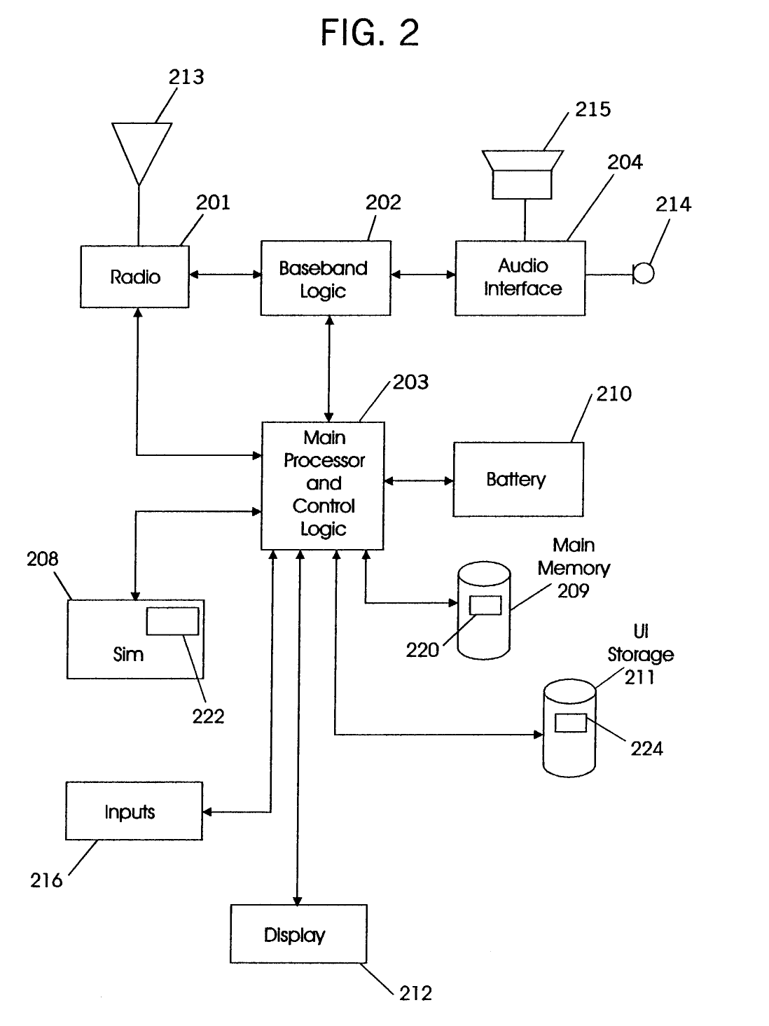

FIG. 2 illustrates a block diagram representative of the internal components of a typical mobile terminal. It should be noted, however, that the mobile terminal of the present invention is not limited to any particular combination of internal components. The mobile terminal of FIG. 2 includes a radio block 201, a baseband logic block 202, a main processor and control logic block 203, and an audio interface block 204. A subscriber identity module (SIM) 208 is shown as operatively connected to the main processor and control logic. Also included are a main memory 209, a battery 210, and UI (User Interface) storage 211. The UI storage may be used to store the data currently being viewed on the display 212. Within the radio block 201, the transmit and receive information is converted to and from the radio frequencies (RF) of the various carrier types, and filtering using baseband or intermediate frequency circuitry is applied, as is understood in the art. The terminal's antenna system 213 is connected to the radio block 201. In the baseband logic block 202, basic signal processing occurs, e.g., synchronization, channel coding, decoding and burst formatting, as is understood in the art. The audio interface block 204 handles voice as well as analog-to-digital (A/D) and D/A processing. It also receives input through a microphone 214, and produces output through speaker 215. The main processor and control logic block 203, coordinates the aforementioned blocks and also plays an important role in controlling the human interface components such as the inputs 216 (representing buttons 108 through 118 of FIG. 1) and the display 212 (representing the display 104 of FIG. 1). The functions of the aforementioned blocks are directed and controlled by processing circuitry such as general-purpose microprocessors, digital signal processors (DSPs), application specific integrated circuits (ASICs), various types of signal conditioning circuitry, including analog-to-digital converters, digital-to-analog converters, input/output buffers, etc. Program code, often in the form of microcode is stored in the main memory 209 and controls the operation of the terminal through the processor or processors. Some aspects of the invention are implemented in some embodiments by the program code controlling the hardware.

The main memory 209 and UI storage 211 may include one or more physical memory devices, which may include volatile storage devices, non-volatile storage devices, or both. For example, memory may include random access memory (RAM), read-only memory (ROM), various forms of programmable and/or erasable (ROM) (e.g., PROM, EPOM, EEPROM, etc.), flash memory, or any combination of such devices. In the present invention, the main memory 209 can store the plurality of network identifiers 220, such as phone number lists, e-mail addresses, and URLs. Note that the plurality of network identifiers 220 may be stored in the main memory in subgroups, such as in a phonebook or in a frequently called numbers list. Further note that the subgroups are not limited to storing only one type of network identifier, but may store any network identifier in any subgroup. For example, the phonebook may contain not only phone numbers, but also e-mail addresses and URLs as well. Some or all of the network identifiers can alternatively be stored in SIM 208. For example, the phonebook can be stored in the SIM instead of or in addition to in the main memory of the mobile terminal.

Referring to FIG. 2, a user enters initial characters of a desired network identifier through the input block 216, which is typically an alphanumeric keypad (as shown at 118 in FIG. 1) in a mobile terminal. The main processor and control logic 203 then searches the plurality of network identifiers 220 stored in the main memory 209 or 222 stored in the SIM, 208, for network identifiers with initial characters that match the characters entered by the user. If matching network identifiers are found, they are grouped as a subset of network identifiers 224. This subset is sent to the display 212 where the user may select one of the subset of network identifiers or enter an additional character to initiate another search. The subset of network identifiers may also be sent to the UI storage 211 via the main processor and control logic 203. The main processor and control logic 203 may then perform repeated searches based on additional entered characters on the subset of network identifiers 224 in the UI storage 211, without searching the main memory 209. It should be noted, however, that the present invention is not limited to storing subsets of network identifiers 224 in any particular memory location.

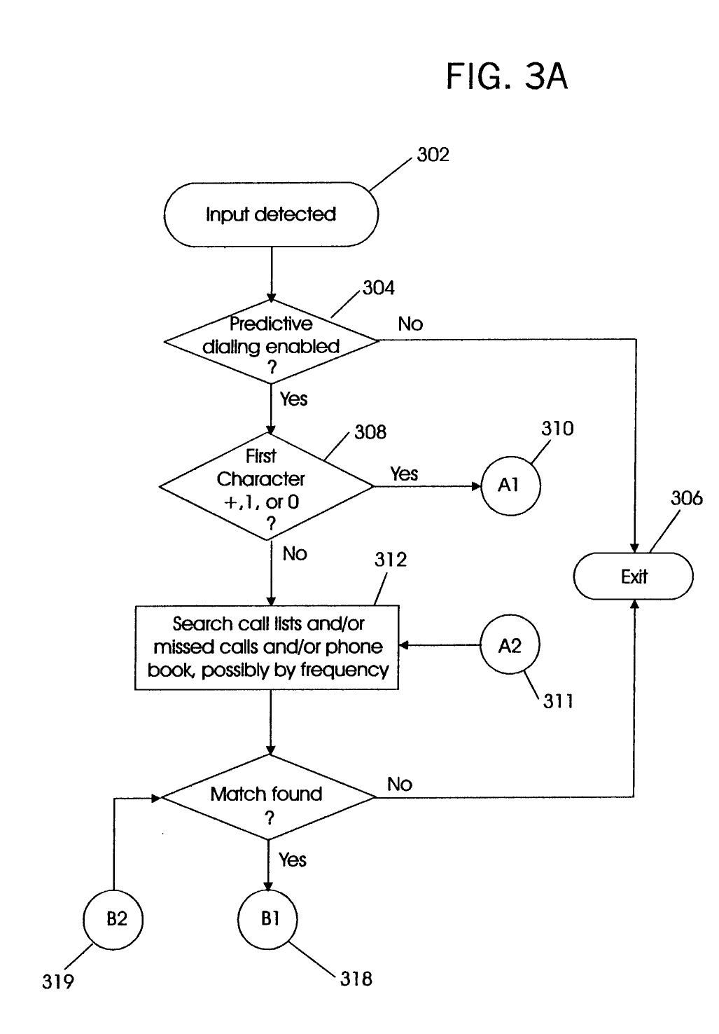

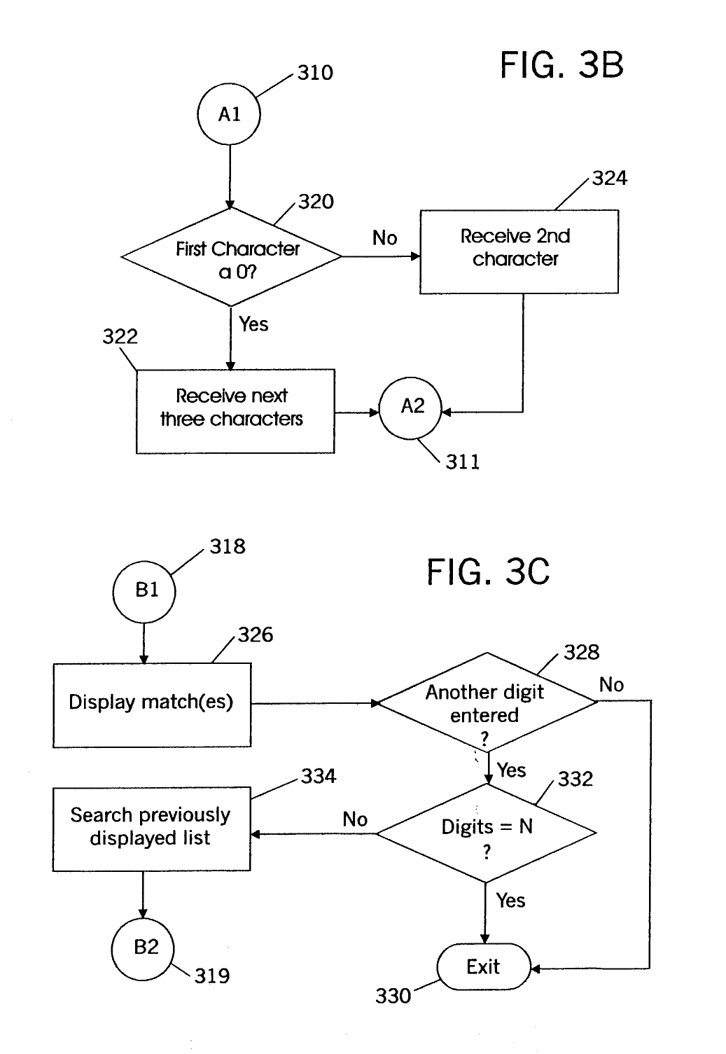

FIG. 3 illustrates a flowchart showing possible steps for performing the present invention. As shown in FIG. 3A, the process begins when a first character is input by a user 302. If predictive dialing is not enabled 304, the process ends 306 and allows the user to continue dialing as usual. If predictive dialing is enabled 304, the process looks at the first character entered by the user. If the first character is a “+,” “1,” or “0” 308, the present invention recognizes that the user is attempting to make a long-distance or international call, and proceeds to “A1” 310, returning at “A2” 311. Note that the “+” sign indicates an international call to the local wireless switching equipment, since the international prefix varies from country to country. If the first character input is not a “+,” “1,” or “0” 308, the process searches 312 the plurality of network identifiers in various storage locations of the mobile terminal to find those network identifiers whose first character matches the entered character. If no matches are found 314, the process ends 306. If matches are found 314, the process continues to “B1” 318, returning at B2, 319.

Note that the initial searching 312 may begin after a differing number of characters have been entered, depending upon the type of call. For international calls, the search 312 may begin after four characters have been entered (the three digits of the international access code plus the first digit of the country code). For long-distance calls, the search 312 may begin after two characters have been entered (“1” plus the first digit of the area code). For all other calls, the search 312 may begin after the first character has been entered. Note that if characters other than those specifically mentioned become indicative of call type, the microcode or software in the phone can be modified accordingly. It is also possibly to provide the user with options to enter this information into one of the setup menus.

FIG. 3B illustrates the condition starting at “A1” 310, where an international or long-distance call is assumed to be desired. If the first character input is a “0” 320, the present invention recognizes that an international call is desired and proceeds to receive the next three characters 322. The receipt of these three characters may be accomplished by such means as a software loop function or a counter. It should be noted, however, that the present invention is not limited to any particular method or means for awaiting, counting, and recognizing receipt of the three additional characters. If the first character is not a “0” 320 (and is therefore either a “1” or a “+”), the invention recognizes that a long-distance call is desired, and a second character is received 324. The process then returns to FIG. 3A at “A2” 311, and continues to search 312 for these entered characters in the plurality of network identifiers stored in various storage locations of the mobile terminal.

The initial search step 312 may decide which of the various storage locations to search first based on the way the user has configured the mobile terminal to store or “log” incoming and outgoing calls. This is known as the call logging setup of the mobile terminal. If the call logging setup is set to a call list comprising incoming, outgoing, and missed calls, the search step will first try to match the entered character(s) with network identifiers in the call list, and then in the phonebooks, which comprises network identifiers that the user has entered him or herself. Note that the phonebook is not limited to a listing of telephone numbers, but may comprise all types of network identifiers (phone numbers, e-mail addresses, and URLs). Also note that the phonebook may reside in the main memory, the SIM, or both. If it resides in both, the search may be conducted against both, “throwing out” any duplicate entries. If the call logging setup is set to a call list comprising outgoing calls only and to a missed call list, the search step will first try to match the entered character(s) with network identifiers stored in the call list, then the phonebook, and then the missed calls list. If the call logging setup is set to a frequently called numbers list (comprising outgoing and incoming calls in the order of frequency) and to a missed call list, the search step will first try to match the entered character(s) with network identifiers stored in the frequently called number list, then the phonebook, and then the missed calls list. The order of the phone number lists (call list, missed calls, phonebook, etc.) used by the search step is based on the probability that the frequently and very recently used number can be found. Note that the order in which the stored lists are searched may also be configurable by the user, and that the present invention is not limited to the above searching order. If the stored lists contain no network identifiers with an initial character that matches the character entered by the user 314, the process ends 306. If a match is found 314, the process continues to “B1” 318.

FIG. 3C illustrates the remainder of the matching process beginning at “B1” 318, when a match between the initial character entered by the user and the initial character of a stored network identifier is found. First, all matches are displayed to the user 326 as a first subset of stored network identifiers. If only one match with the entered characters is found, the not yet entered characters will be appended to the entered characters on-screen. If more than one match is found, the numbers will be displayed in a drop-down window. In either case, the numbers not entered by the user (latter part of each number) may be optionally grayed out so that the user knows what was entered and what is being “proposed” by the phone. The matches may be shown in the order of list in which a number appears, and/or of frequency and/or of descending numbers, or some combination. For example, the frequently called number list numbers can be displayed first and those can be displayed in order of frequency, followed by numbers from the phonebook in numerical order. If the user selects one of these matches and initiates a call (i.e. other characters are not entered) 328, the process ends 330. However, if another character is entered 328, and the total number of characters entered does not equal a pre-set limit N 332 (which may be set by the user depending upon the type of call), the invention searches the previously displayed subset of network identifiers 334 for the characters entered thus far, and returns to FIG. 3A at “B2” 319 for the match step 314. If matches are found 314 between the entered characters and the network identifiers in the previously displayed subset of network identifiers, the process returns to “B2” 319 and, returning to FIG. 3B, displays the new matches 326 as a reduced subset of network identifiers. If the user selects one of these matches and initiates a call (i.e. other characters are not entered) 328, the process ends at 330. If the user enters an additional character 328, the process repeats. Thus, the matching criteria is adjusted as the user continues entering digits. If the matching process comes up negative (i.e. no match is found) 314, the process ends 316. The process also ends 330 if the limit N is met 332. Additionally, a timer can end the process (not shown) if a pre-selected amount of time has passed with no entries.

The pre-set limit N may depend on whether the type of call is international, long-distance, or any other call. For international calls, the process will end once 10 characters have been entered. For long-distance calls, the process ends after 8 characters have been entered. For all other calls, the process ends once 5 characters have been entered. It should be noted, however, that the present invention is not limited in its use to any particular pre-set limit N. The limit N may be set by the user to allow as few or as many entered characters as she or he chooses before the process ends.

The same principles of predictive input mentioned above may also be applied to Internet addresses, such as e-mail addresses and URLs. Note that the present invention allows all network identifiers to be stored in the same memory location. However, the present invention is not limited to storing network identifiers in any one particular memory location. Also, predictive entry of e-mail addresses and URLs may take place in the same or in designated separate input GUIs (Graphical User Interfaces).

While the present invention is described herein in the context of a mobile terminal, the term “mobile terminal” may include a cellular radiotelephone with or without a multi-line display; a Personal Communications System (PCS) terminal that may combine a cellular telephone with data processing, facsimile and data communications capabilities; a Personal Digital Assistant (PDA) that can include a radiotelephone, pager, Internet/intranet access, Web browser, organizer, calendar and/or a global positioning system (GPS) receiver; and a conventional laptop and/or palmtop receiver or other computer system that includes a display for GUI. Mobile terminals may also be referred to as “pervasive computing” devices. The present invention may be embodied as a cellular communications system, method, and/or computer program product. Accordingly, the present invention may be embodied in hardware and/or in software (including firmware, resident software, micro-code, etc.).

Specific embodiments of the present invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for” are not intended to be read as means-plus-function elements, even if the claim otherwise includes the word “means”.

1. A method of selecting a specific network identifier from among a plurality of stored network identifiers for use in initiating a connection from a mobile terminal, the method comprising:
receiving a number of initial characters of the specific network identifier being input by a user of the mobile terminal;
searching the plurality of stored network identifiers for a first subset of stored network identifiers, wherein each stored network identifier of the first subset of stored network identifiers is a potential match for the specific network identifier based on the number of initial characters;
displaying the first subset of stored network identifiers to the user as a displayed subset of stored network identifiers;
if and when the user enters additional characters of the specific network identifier, repeatedly searching the displayed subset of stored network identifiers after receipt of each additional character of the specific network identifier for an improved potential match for the specific network identifier and displaying, at each iteration, an additional, reduced subset of stored network identifiers as the displayed subset of stored network identifiers; and
receiving a user selection of one of the displayed subset of stored network identifiers as the specific network identifier.

2. The method of claim 1 wherein the searching is accomplished at least in part by first searching a call list, and then searching a phonebook.

3. The method of claim 2 wherein the searching is further accomplished at least in part by searching a missed calls list after searching the phonebook.

4. The method of claim 1 wherein the searching step is accomplished at least in part by first searching a frequently called number list.

5. The method of claim 4 wherein the displaying step is accomplished at least in part by displaying stored network identifiers retrieved from the frequently called number list in order of frequency.

6. The method of claim 1 wherein the stored network identifiers include Internet addresses.

7. The method of claim 1 wherein the number of initial characters depends on the type of call indicated by the first character.

8. The method of claim 3 wherein the number of initial characters depends on the type of call indicated by the first character.

9. The method of claim 5 wherein the number of initial characters depends on the type of call indicated by the first character.

10. The method of claim 1 wherein the repeatedly searching is suspended after a preselected number of characters of the specific network identifier have been entered.

11. The method of claim 3 wherein the repeatedly searching is suspended after a preselected number of characters of the specific network identifier have been entered.

12. The method of claim 5 wherein the repeatedly searching is suspended after a preselected number of characters of the specific network identifier have been entered.

13. The method of claim 7 wherein the repeatedly searching is suspended after a preselected number of characters of the specific network identifier have been entered.

14. The method of claim 8 wherein the repeatedly searching is suspended after a preselected number of characters of the specific network identifier have been entered.

15. The method of claim 9 wherein the repeatedly searching is suspended after a preselected number of characters of the specific network identifier have been entered.

16. An apparatus for enabling the selection of a specific network identifier from among a plurality of stored network identifiers for use in initiating a connection from a mobile terminal, the apparatus comprising:
means for receiving a number of initial characters of the specific network identifier being input by a user of the mobile terminal;
means for searching the plurality of stored network identifiers for a first subset of stored network identifiers, wherein each stored network identifier of the first subset of stored network identifiers is a potential match for the specific network identifier based on the number of initial characters;
means for displaying the first subset of stored network identifiers to the user as a displayed subset of stored network identifiers;
means for repeatedly searching the displayed subset of stored network identifiers after receipt of each additional character of the specific network identifier for an improved potential match for the specific network identifier and displaying, at each iteration, an additional, reduced subset of stored network identifiers as the displayed subset of stored network identifiers; and
means for receiving a user selection of one of the displayed subset of stored network identifiers as the specific network identifier.

17. The apparatus of claim 16 wherein the means for searching further comprises:
means for searching a call list; and
means for searching a phonebook.

18. The apparatus of claim 17 wherein the means for searching further comprises means for searching a missed calls list.

19. The apparatus of claim 16 wherein the means for searching further comprises means for searching a frequently called number list.

20. The apparatus of claim 19 wherein the means for displaying further comprises means for displaying stored network identifiers retrieved from the frequently called number list in order of frequency.

21. The apparatus of claim 16 wherein the stored network identifiers include Internet addresses.

22. The apparatus of claim 16 wherein the number of initial characters depends on the type of call indicated by the first character.

23. The apparatus of claim 18 wherein the number of initial characters depends on the type of call indicated by the first character.

24. The apparatus of claim 20 wherein the number of initial characters depends on the type of call indicated by the first character.

25. The apparatus of claim 16 wherein the means for repeatedly searching is operable to suspend repeatedly searching after a preselected number of characters of the specific network identifier have been entered.

26. The apparatus of claim 18 wherein the means for repeatedly searching is operable to suspend repeatedly searching after a preselected number of characters of the specific network identifier have been entered.

27. The apparatus of claim 20 wherein the means for repeatedly searching is operable to suspend repeatedly searching after a preselected number of characters of the specific network identifier have been entered.

28. The apparatus of claim 22 wherein the means for repeatedly searching is operable to suspend repeatedly searching after a preselected number of characters of the specific network identifier have been entered.

29. The apparatus of claim 23 wherein the means for repeatedly searching is operable to suspend repeatedly searching after a preselected number of characters of the specific network identifier have been entered.

30. The apparatus of claim 24 wherein the means for repeatedly searching is operable to suspend repeatedly searching after a preselected number of characters of the specific network identifier have been entered.

31. A mobile terminal comprising:
a user interface operable to receive user input and display information; and
a processing platform further comprising instructions to enable the selection of a specific network identifier from among a plurality of stored network identifiers by receiving a number of initial characters of the specific network identifier through user input, searching the plurality of stored network identifiers for a first subset of stored network identifiers representing potential matches for the specific network identifier, displaying the first subset of stored network identifiers as a displayed subset of stored network identifiers, and repeatedly searching the displayed subset of network identifiers and redisplaying a reduced subset of stored network identifiers after receipt of each additional character for an improved potential match until a selection of a displayed network identifier.

32. The mobile terminal of claim 31 further comprising user interface (UI) storage for storing the displayed subset of network identifiers.

33. The mobile terminal of claim 31 wherein the searching is accomplished at least in part by first searching a call list, and then searching a phonebook.

34. The mobile terminal of claim 33 wherein the searching is accomplished at least in part by also searching a missed calls list.

35. The mobile terminal of claim 32 wherein the searching is accomplished at least in part by first searching a call list, and then searching a phonebook.

36. The mobile terminal of claim 35 wherein the searching is accomplished at least in part by also searching a missed calls list.

37. The mobile terminal of claim 31 wherein the searching is accomplished at least in part by first searching a frequently called number list.

38. The mobile terminal of claim 32 wherein the searching is accomplished at least in part by first searching a frequently called number list.

39. The mobile terminal of claim 37 wherein the displaying is accomplished at least in part by displaying stored network identifiers retrieved from the frequently called number list in order of frequency.

40. The mobile terminal of claim 38 wherein the displaying is accomplished at least in part by displaying stored network identifiers retrieved from the frequently called number list in order of frequency.

41. The mobile terminal of claim 31 wherein the stored network identifiers can include Internet addresses.

42. The mobile terminal of claim 32 wherein the stored network identifiers can include Internet addresses.

43. The mobile terminal of claim 31 wherein the number of initial characters depends on the type of call indicated by the first character.

44. The mobile terminal of claim 31 wherein searching can be suspended after a preselected number of characters of the specific network identifier have been entered.

45. The mobile terminal of claim 32 wherein the number of initial characters depends on the type of call indicated by the first character.

46. The mobile terminal of claim 32 wherein searching can be suspended is after a preselected number of characters of the specific network identifier have been entered.
